(19) United States
(12) Patent Application Publication
(10) Pub. No.: US 2025/0385598 A1
(43) Pub. Date: Dec. 18, 2025

(54) Inverter System and Methods

(71) Applicant: Vroom Solar Inc., Springfield, MO (US)

(72) Inventors: Luke Phelps, Springfield, MO (US); James Bartley, Springfield, MO (US)

(73) Assignee: Vroom Solar Inc., Springfield, MO (US)

(21) Appl. No.: 19/202,574

(22) Filed: May 8, 2025

Related U.S. Application Data
(60) Provisional application No. 63/661,106, filed on Jun. 18, 2024.

(51) Int. Cl. H02M 1/32; H02M 1/00; H02M 7/539

(52) U.S. Cl. CPC H02M 1/32; H02M 1/0009; H02M 7/539

(57) ABSTRACT

A power inverter system, a method for forecasting available power, and a method for dynamically shedding/loading one or more outlets.

### CROSS-REFERENCE TO RELATED APPLICATIONS

The present application claims priority to U.S. Provisional Ser. No. 63/661,106, filed Jun. 18, 2024, entitled “Inverter System and Methods,” the disclosure of which is hereby incorporated by reference in its entirety as if fully set forth herein.

### FIELD

The present disclosure relates generally to inverter systems and/or methods.

### BACKGROUND

There is often a need to provide electrical power to alternating current (AC) loads in remote areas where the electric power grid is not reliable or available. The electrical AC loads may include a storage battery, a power outlet, an electrical tool, an air conditioner or heater, a charger for electrical vehicles, or the like. This situation may occur at a building construction site where electric power service has not yet been provided. The situation may also occur in countries where the infrastructure for providing electrical power does not exist. It may also be desirable to provide an alternate source of electrical power in the aftermath of a disaster such as a storm, earthquake or other catastrophe causing damage to the electrical generation and distribution infrastructure. Needs for a power source may similarly arise at other remote locations such as major special events, concerts, and at remote cabins and campsites.

Photovoltaic (PV) cells or panels are one form of an alternative energy source which generate a direct current (DC). Other sources include wind power and hydraulic power. The voltage from the PV panels (referred to herein as “input power” or “available power”) is typically combined with a power controlling unit, comprising an inverter for changing the DC voltage to AC voltage in order to power the load (referred to herein as “output power”). In the case of the photovoltaic panels, for example, the amount of power that can be extracted from the photovoltaic array depends on the conditions of radiation or sunlight, i.e. the amount of solar energy striking the panels or cells. Herein, the term “irradiance” will be used to describe the amount of solar energy striking the solar cells. As the solar irradiance diminishes, the input power that can be extracted from the photovoltaic array diminishes. Of course, there are other factors which affect the efficiency of power conversion using PV cells, including temperature, however, this disclosure will focus on irradiance as the primary factor. The sunlight versus time curve is ideally a substantially continuous and predictable curve. As the sun rises in the morning the irradiance curve increases to midday, after which the curve begins decreasing until the curve goes to zero as the sun sets. However, in reality, during the day when the sun is suddenly obscured by clouds and then reappears from behind the clouds, the amount of power radiated is unpredictably and significantly modified. The unpredictable nature of the sun's power negatively affects a PV cell's ability to produce electric power. It is particularly problematic in PV systems producing “on demand” power where the AC is being used to power a device for immediate use (as opposed to charging a battery). Installation of PV cells or panels may be cost prohibitive to consumers due to net metering changes and battery cost. Further, the limited power distribution capabilities of existing systems require the implementation of such costly batteries.

All PV panels have a maximum power point (MPP) which is usually specified by the manufacturer. The MPP is the optimal conditions where the PV panels produce the most electricity. This MPP is affected by both the immediate environment like temperature and shading, as well as irradiance levels (the amount of solar radiation that hits the panel). Some existing power controlling units dynamically measure the voltage and current in a process called maximum power point tracking (MPPT). MPPT constantly tracks the panels' MPP and then adjust the panels' output to optimize performance. However, existing MPPT systems require an active load to draw power for measurement to take place and maximum power is not always relevant or required by the user. For example, many users may want to know whether the PV panels can generate enough power for one or more specified functions before an active load is connected.

One approach to estimating available power is short circuit current measurements. However, existing short-circuit current (ISC) measurements are often performed offline: a disconnect mechanism isolates the panels, which are then briefly shorted to measure current. This disrupts power delivery and risks stressing components of an inverter. Various solutions like short-circuit pulses, open-circuit voltage checks, or external irradiance sensors either reduce output, add hardware cost, or rely on approximations.

### BRIEF SUMMARY

The present application overcomes the disadvantages of the prior art by providing a an inverter system, comprising: a power inverter assembly configured to receive a DC voltage signal from a renewable energy source and convert the DC voltage signal to a first AC voltage signal; a relay matrix configured to receive the first AC voltage signal from the power inverter assembly and a second AC voltage signal from an external power source in order to selectively power one or more outlets.

In one example, the power inverter assembly includes one or more single gate drivers configured to galvanically isolate digital and analog components from high voltage components.

In one example, the power inverter assembly includes a first controller comprising a sinusoidal pulse width modulator (SPWM).

In one example, the renewable energy source includes one or more photovoltaic panels.

In one example, the external power source is one of: a generator, or an electrical grid.

In one example, the system further includes a forecaster module configured to determine an expected power from the renewable energy source, the forecaster module including a shorting circuit.

In one example, the shorting circuit includes an LR series circuit such that the forecaster module is configured to measure the expected power from the renewable energy source without a load electrically connected to the renewable resource.

In one example, the system further includes one or more current sensors configured to measure a current draw at each of the one or more outlets.

Another aspect of the disclosure provides a method of load switching and/or shedding, comprising: measuring one or more current values associated with one or more outlets; determining an expected power from a renewable energy source; and dynamically powering the one or more outlets from the renewable energy source or an external power supply.

In one example, the one or more outlets comprises four duplex outlets, each of the duplex outlets having a predetermined priority.

In one example, the determining the expected power from the renewable energy source includes forecasting the expected power with a shorting circuit.

Another aspect of the disclosure provides a method of forecasting an expected power, comprising: drawing current from a renewable energy resource with a shorting circuit for a time less than a shorting circuit time constant; measuring at least one current value at the shorting circuit; measuring at least one voltage value at the renewable energy resource; determining an expected power of the renewable resource based upon the at least one current value, the at least one voltage value, and at least one parameter of the renewable energy source.

In one example, the shorting circuit includes an LR series circuit and the shorting circuit time constant is an LR time constant.

In one example, the determining the expected power of the renewable resource is performed without a load electrically connected to the renewable resource.

Another aspect of the disclosure provides an inverter system, comprising: a power inverter assembly configured to receive a DC voltage signal from a renewable energy source and convert the DC voltage signal to a first AC voltage signal; a relay matrix configured to receive the first AC voltage signal from the power inverter assembly and a second AC voltage signal from an external power source in order to selectively power one or more outlets.

In one example, the power inverter assembly includes one or more single gate drivers configured to galvanically isolate digital and analog components from high voltage components.

In one example, the power inverter assembly includes a first controller comprising a sinusoidal pulse width modulator (SPWM).

In one example, the renewable energy source includes one or more photovoltaic panels.

In one example, the external power source is one of: a generator, or an electrical grid.

In one example, the inverter system further includes: a forecaster module configured to measure a current from the renewable energy source, the forecaster module including: a first short circuit path including a first transistor and a first resistor; and a second short circuit path including a second transistor and a second resistor.

In one example, the first transistor and the second transistor each comprise an insulated gate bipolar transistor (IGBT).

In one example, the first resistor has a greater resistance than the second resistor.

In one example, the inverter system further includes: one or more current sensors configured to measure a current draw at each of the one or more outlets.

Another aspect of the disclosure provides a method of load switching and/or shedding, comprising: measuring one or more current values associated with one or more outlets; determining an available power from a renewable energy source; and dynamically powering the one or more outlets from the renewable energy source or an external power supply.

In one example, the one or more outlets comprises four duplex outlets, each of the duplex outlets having a predetermined priority.

In one example, the determining the available power from the renewable energy source includes determining a short circuit current (ISC) of the renewable energy source.

Another aspect of the disclosure provides a method of determining a short circuit current of a renewable energy source, comprising: enabling a first short circuit path having a first transistor and a first resistor such that current is drawn from a renewable energy source; enabling a second short circuit path having a second transistor and a second resistor such that current is drawn from the renewable energy source, the second resistor having a resistance that is less than a resistance of the first resistor; disabling the second short circuit path; measuring a current of the first short circuit path; disabling the first short circuit path; and determining a short circuit current of the renewable energy source based upon the measured current.

In one example, the renewable energy source is operatively connected to an inverter system, and the first short circuit path is disabled before interrupting power to at least one load operatively connected to the inverter system.

In one example, wherein the measured current stabilizes at a short circuit current (ISC) plateau.

In one example, the first short circuit path includes a first gate driver and the second short circuit path includes a second gate driver.

In one example, an output of the second gate driver when the second short circuit path is enabled comprises a pulse width modulated (PWM) signal.

In one example, the pulse width modulated (PWM) signal has a variable frequency based in part on a current measured after the first short circuit path is enabled.

In one example, the second short circuit path is enabled for a duration of approximately 650 microseconds.

In one example, the method further includes determining an available power based in part upon the determined short circuit current (ISC).

### BRIEF DESCRIPTION OF THE DRAWINGS

A more complete appreciation of the subject matter of the present disclosure and the various advantages thereof can be realized by reference to the following detailed description in which reference is made to the accompanying drawings in which:

FIG. 1A is a side perspective view of an inverter system according to one or

more aspects of the disclosure;

FIG. 1B is a top view of an inverter system according to one or more aspects of the disclosure;

FIG. 1C is a side view of an inverter system according to one or more aspects of the disclosure;

FIG. 1D is a block diagram of an inverter system 100 according to one or more aspects of the disclosure;

FIG. 2 is a circuit diagram of the reverse polarity protection circuit and sensor of FIG. 1D;

FIG. 3 is a circuit diagram of a voltage converter that supplies power to the inverter system and any components or subcomponents thereof;

FIG. 4 is a circuit diagram of a voltage converter that supplies power to the inverter system and any components or subcomponents thereof;

FIG. 5 is a circuit diagram of a voltage converter that supplies power to the inverter system 100 and any components or subcomponents thereof;

FIGS. 6A-D are circuit diagrams of voltage supplies for single gate drivers of the inverter system;

FIG. 7 is a circuit diagram of the controller 116;

FIG. 8 is an overcurrent regulator that can be implemented within the one or more regulators depicted in FIG. 1D;

FIG. 9 is an overvoltage regulator that can be implemented within the one or more regulators depicted in FIG. 1D;

FIG. 10 is an AC regulator that can be implemented within the one or more regulators depicted in FIG. 1D;

FIG. 11 is an undervoltage regulator that can be implemented within the one or more regulators depicted in FIG. 1D;

FIG. 12 shows a controller electrically connected with a power switch and a bus switch;

FIG. 13 is a port corresponding to the controller;

FIG. 14 is an analog to digital converter (ADC) configured to convert one or

more analog signals to one or more digital signals;

FIGS. 15-16 are additional 12C interfaces and configured to electrically connect to bus switch;

FIG. 17 is a port expander electrically connectible to the bus switch;

FIG. 18 are GPS connection interfaces configured to electrically connect to bus switch;

FIG. 19 shows a high voltage switching assembly for a generating a filtered first AC signal PV_SW1;

FIG. 20 shows a high voltage switching assembly for a generating a filtered second AC signal PV_SW2;

FIG. 21 shows an AC regulation assembly for the first and second outlets;

FIG. 22 shows an AC regulation assembly for the third and fourth outlets;

FIG. 23 shows a remote start interface for generator;

FIG. 24 is an electrical model of a forecaster module according to one or more aspects of the disclosure;

FIG. 25 is a method of forecasting, using the forecasting module, according to one or more aspects of the disclosure;

FIG. 26 is a graph of current (in amps) vs. time of a response curve, showing current values as across the LR series circuit;

FIG. 27 is a partial schematic of the shorting circuit electrically connected with the controller;

FIG. 28 is a block diagram of an inverter system incorporating an exemplary forecaster module operatively connected to a current source according to one or more aspects of the disclosure;

FIG. 29 is a schematic diagram of a forecaster according to one or more aspects of the disclosure;

FIG. 30 is a flow chart depicting a method of determining a short circuit current (ISC) according to one or more aspects of the disclosure;

FIG. 31 is an oscilloscope output of current vs. time showing the various stages of the method of FIG. 30, including output of first gate driver, the output of second gate driver, and measured current by current sensor;

FIG. 32 is a graph showing current (A) vs. current measurement sample number showing stabilization of measured current about the ISC plateau of various powers and loads;

FIG. 33 is a method of determine a power source for one or more outlets according to one or more aspects of the disclosure; and

FIG. 34 is a method of load shedding according to one or more aspects of the disclosure.

### DETAILED DESCRIPTION

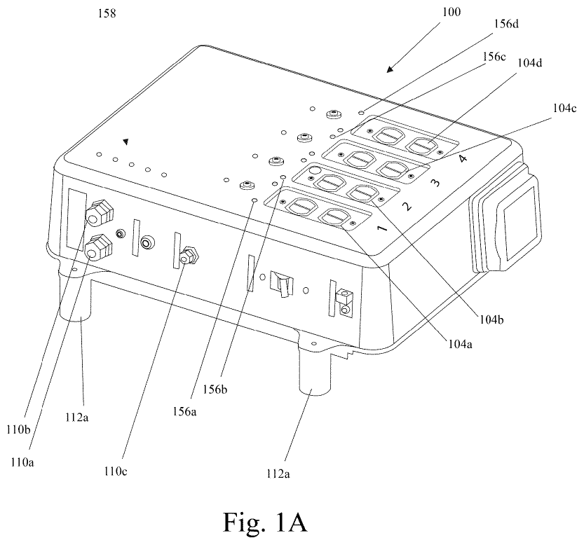

FIG. 1A is a side perspective view of an inverter system 100 according to one or more aspects of the disclosure. FIG. 1B is a top view of an inverter system 100 according to one or more aspects of the disclosure. FIG. 1C is a side view of an inverter system 100 according to one or more aspects of the disclosure. Further inverter system implementations can be found in US 2024/0014652 A1 to Phelps et al., the disclosure of which is herein incorporated by reference.

The inverter system 100 can have a housing 102a that is substantially cuboid in shape. In this regard, the housing 102a can have one or more rounded edges between adjacent faces. The housing 102a can be formed of any type of material, such as a metal or a polymer, or any combination thereof. In one particular example, the housing is formed of stainless steel.

The inverter system 100 can have a plurality of outlets 104a-d configured to receive one or more electrical plugs in order to power an external load. In the example of FIG. 1A, the inverter system 100 has four duplex electrical outlets. In other examples, the inverter system 100 can have any number of electrical outlets depending on the use case. While the outlets depicted are American style type B plugs with two flat parallel pins and a grounding pin, the outlets can be any type of outlet configuration such as international outlets or USB-A outlets.

As shown, the outlets can include a first group of outlets 104a, a second group of outlets 104b, a third group of outlets 104c, and a fourth group of outlets 104d. The outlets can be any type of electrical outlets, and in one example are 110V, 15 A outlets. One or more external loads can be plugged into outlets 104a-d such that the external loads may be powered by the inverter system 100, either by a renewable energy source and/or an external power source, as will be explained in greater detail below.

The housing 102a can include one or more indicators 156a-d corresponding to the plurality of outlets 104a-d. In this regard, each group of outlets 104a, b, c, d can have a corresponding group of indicators 156a, b, c, d indicating a status of the respective outlets. As shown, the indicators are LED lights having a red color or green color, but any type of indicator (audio, visual, or otherwise) can be implemented. In one example, a green indicator for an outlet can indicate that power is being supplied to that particular outlet by a renewable energy source while a red indicator can indicate that power is being supplied to that particular outlet by an external power source.

The housing 102a can also include one or more indicators 158 indicative of an amount of input power provided from a respective renewable energy source. In one example, the housing can include up to five LED indicators of various colors, such as one red, one orange, and three green LEDs. The red LED alone may be activated where there are at least 100 W of expected power from the renewable energy source. The orange LED alone may be activated where there are at least 200 W of expected power from the renewable energy source. A first green LED alone may be activated where there are at least 300 W of expected power from the renewable energy source. A second green LED alone may be activated where there are at least 400 W of expected power from the renewable energy source. A third green LED alone may be activated where there are at least 500 W of expected power from the renewable energy source. The expected power can be determined according to a method of forecasting, as will be explained in greater detail below.

The housing 102a can include a plurality of inputs 110a-c configured to allow an external device to connect to the inverter system 100 by a wired connection.

The inverter system 100 can also include a plurality of legs 112a that extend downwardly from the housing 102a to allow the inverter system 100 to be placed upon a surface while providing clearance for a heat sink assembly 114a, with the heat sink assembly 114a being a plurality of blades or fins thermodynamically coupled to one or more components of the inverter system 100 and configured to dissipate excess heat generated by the inverter system 100. The housing 102a can also include a chair lug for grounding.

FIG. 1D is a block diagram of an inverter system 100 according to one or more aspects of the disclosure.

The inverter system 100 can electrically connect to (or can include) a renewable power source 102. The renewable power source 102 can be any type of power source that provides a DC voltage, such as solar power source(s), and/or wind power source(s) and/or hydroelectric power source(s) and/or mechanical power source and/or thermal power source, and/or any combination thereof.

In one example, the renewable power source 102 can include one or more photovoltaic (PV) panels. The one or more PV panels can be connected to each other in any combination of serial or parallel. The PV panels can be any type of panels, such as monocrystalline, polycrystalline, and/or thin film, and can have any operating parameters, such as voltage at open circuit (Voc), voltage at maximum power point (Vmp), open circuit current (Isc), current at max power (Imp), etc. In one example, the PV panels are in the range of 141V to 305V Voc.

The inverter system 100 can electrically connect to (or can include) a capacitor 104. As shown, the capacitor can electrically connect to both the renewable power source 102 (e.g., PV panel(s)) and the reverse polarity protection circuit 106 such that at least some power generated by renewable power source 102 can be temporarily or permanently stored with capacitor 104.

The capacitor 104 can be of any type of capacitor with any capacitance value and/or voltage rating. For example, the capacitor 104 can be a bulk capacitor having a capacitance of up to 5000 microfarads. In one example, the capacitor 104 is a bulk capacitor having a capacitance of approximately 3300 microfarads.

The system 100 can also include reverse polarity protection circuit 106 and/or a sensor 108. The reverse polarity circuit 106 can be configured prevent other components (e.g., semiconductors) of the system 100 from entering reverse bias in the case of high overvoltage under reverse polarity. The sensor 108 can be any type of sensor, such as a voltage sensor, a current sensor, or a combined voltage and current sensor.

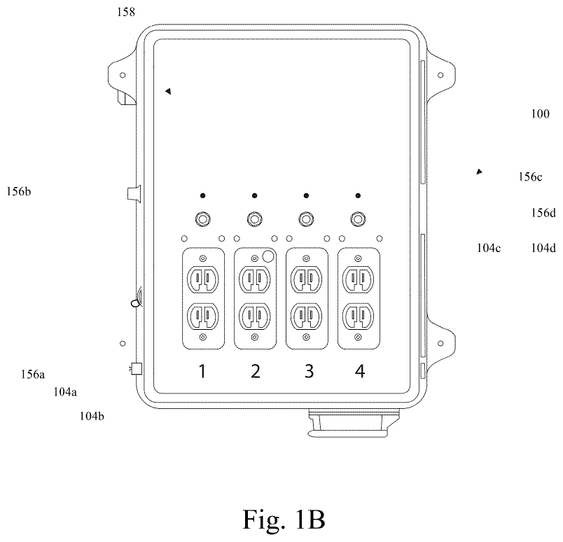

FIG. 2 is a circuit diagram of the reverse polarity protection circuit 106 and sensor 108 of FIG. 1D. As shown in FIG. 2, the reverse polarity protection circuit 106 can include at least one or more diodes 106a and/or one or more FETs 106b in electrical communication with the renewable power source 102. The sensor 108 can be a current sensor (e.g., monolithic Hall effect current sensor IC) configured to measure a current and/or voltage from the renewable power source 102. The sensor 108 can be a current and/or voltage sensor configured to measure a current and/or voltage out of the reverse polarity protection circuit 106.

The sensor 108 can output one or more signals from the VIOUT and/or FAULT pins. For example, the sensor 108 can output a first output signal CURRENT SENSE from the VIOUT pin representative of sensed current. The sensor 108 can also output a second output signal SHORT_CIRCUIT_FLT from the FAULT pin indicative of an short circuit fault. The first and second outputs CURRENT_SENSE and SHORT_CIRCUIT_FLT can be provided to controller 116, as will be described below.

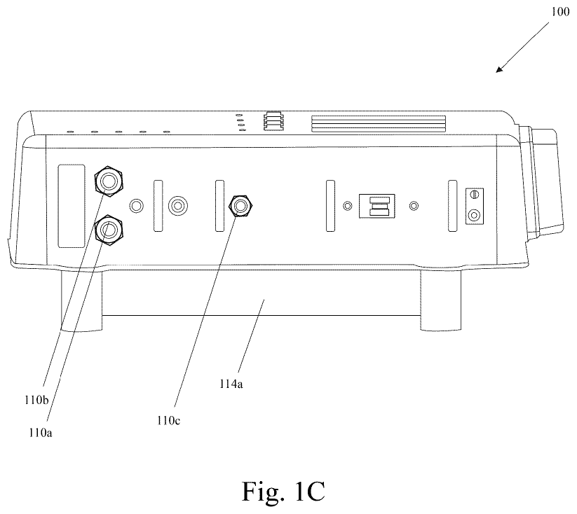

FIG. 3 is a circuit diagram of a voltage converter 300 that supplies power to the inverter system 100 and any components or subcomponents thereof. The voltage converter 300 can include a DC-DC converter 302 rated for a 12V DC output. Optionally, the voltage converter 300 can include a Kelvin connection 304 to allow for more accurate measurement of resistance, voltage, and/or current. While not depicted in the block diagram of FIG. 1D, the voltage converter 300 can be incorporated within housing 102a of inverter system 100 and can be electrically connected and provide power to either controller 116 and/or controller 148.

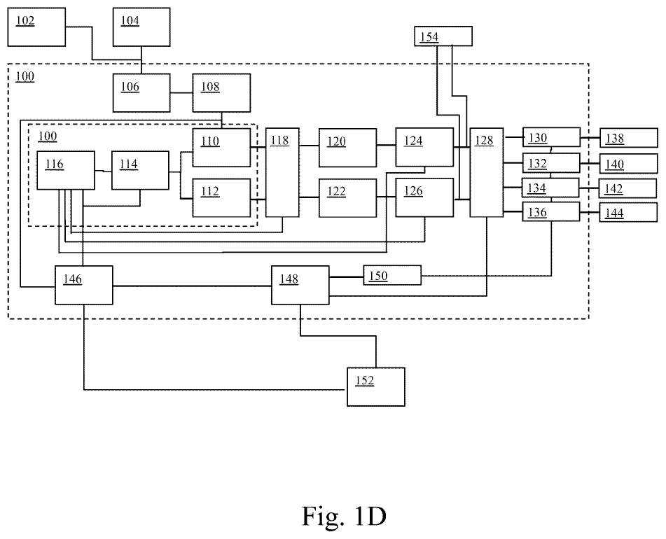

FIG. 4 is a circuit diagram of a voltage converter 400 that supplies power to the inverter system 100 and any components or subcomponents thereof. The voltage converter 400 can include a DC-DC converter 402 rated for a 5V DC output and be electrically connected to the voltage converter 300 in order to receive a 12V DC power supply. While not depicted in the block diagram of FIG. 1D, the voltage converter 400 can be incorporated within housing 102a of inverter system 100 and can be electrically connected and provide power to either controller 116 and/or controller 148.

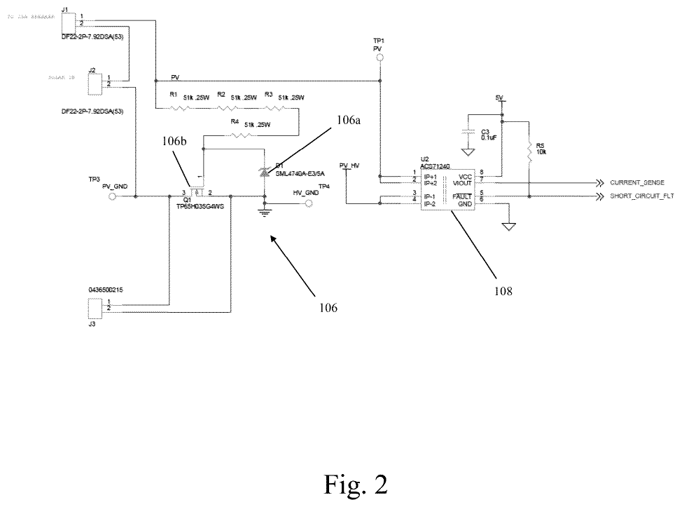

FIG. 5 is a circuit diagram of a voltage converter 500 that supplies power to the inverter system 100 and any components or subcomponents thereof. The voltage converter 500 can include a DC-DC converter 502 rated for a 3.3V DC output and be electrically connected to the voltage converter 400 in order to receive a 5V DC power supply. While not depicted in the block diagram of FIG. 1D, the voltage converter 500 can be incorporated within housing 102a of inverter system 100 and can be electrically connected and provide power to either controller 116 and/or controller 148.

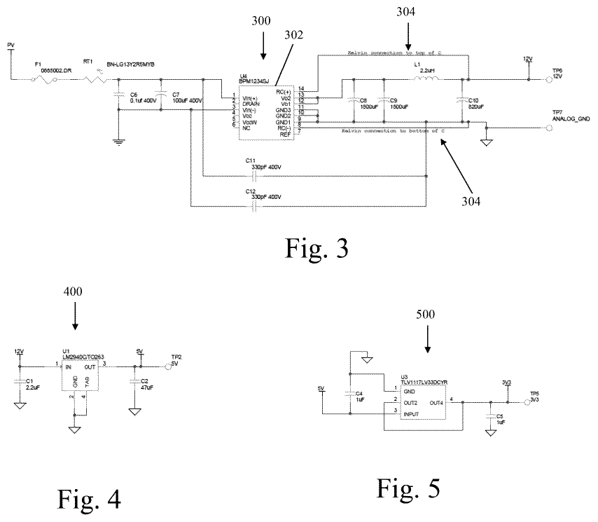

FIGS. 6A-D are circuit diagrams of voltage supplies 600a-d for single gate drivers (e.g., single gate driver(s) 114) of the inverter system 100. Each of the voltage supplies 600a-d can include a DC-DC converter 602a-d rated for a 15V DC output. While not depicted in the block diagram of FIG. 1D, the voltage converter supplies 600a-d can be incorporated within housing 102a of inverter system 100 and can be electrically connected and provide power to single gate drivers (e.g., single gate driver(s) 114).

The voltage supply 600a can output one or more power signals VGH_L_SK and/or GNDISO_VGH_L. The first output VGH_L_SK can be a high side gate voltage for single gate drivers associated with a LINE signal and the second output GNDISO_VGH_L can be a ground.

The voltage supply 600b can output one or more power signals VGH_N_SK and/or GNDISO_VGH_N. The first output VGH_N_SK can be a high side gate voltage for single gate drivers associated with a NEUTRAL signal and the second output GNDISO_VGH_N can be a ground.

The voltage supply 600c can output one or more power signals VGL_L_SK and/or GNDISO_VGL_L. The first output VGL_L_SK can be a low side gate voltage for single gate drivers associated with a LINE signal and the second output GNDISO_VGL_L can be a ground.

The voltage supply 600d can output one or more power signals VGL_N_SK and/or GNDISO_VGL_N. The first output VGL_N_SK can be a low side gate voltage for single gate drivers associated with a NEUTRAL signal and the second output GNDISO_VGL_N can be a ground.

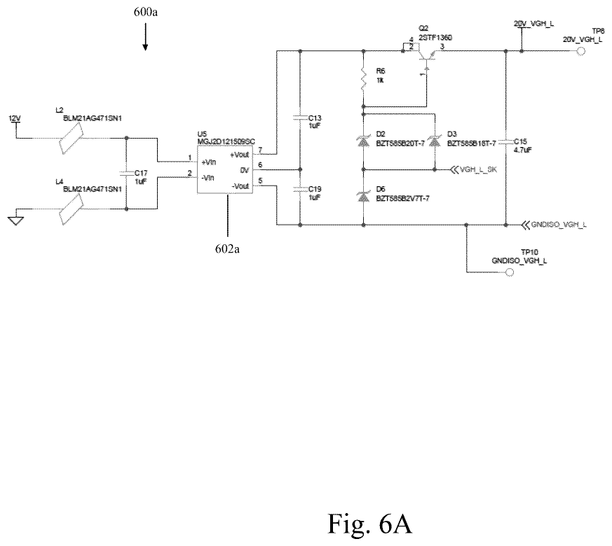

FIG. 7 is a circuit diagram of the controller 116. The controller 116 can be any type of programmable system on a chip having a 32-bit processor. In one example, the controller 116 is a PSoC® 5LP manufactured by Cypress. The controller 116 can be capable of sinusoidal pulse width modulation (SPWM) in order to synthesize one or more sine waves from a one or more digital pulses.

As shown, the controller 116 can receive signals SHORT_CIRCUIT_FLT and CURRENT_SENSE from reverse polarity protection circuit 106 and sensor 108.

The controller 116 can also receive a signal PSOC_ENABLE from controller 148. The PSOC_ENABLE signal can serve as an activation signal that activates the controller 116 to produce the A C output voltage.

The controller 116 can generate a high side modulated sine wave SPWM P and a low side modulated sine wave SPWM_M.

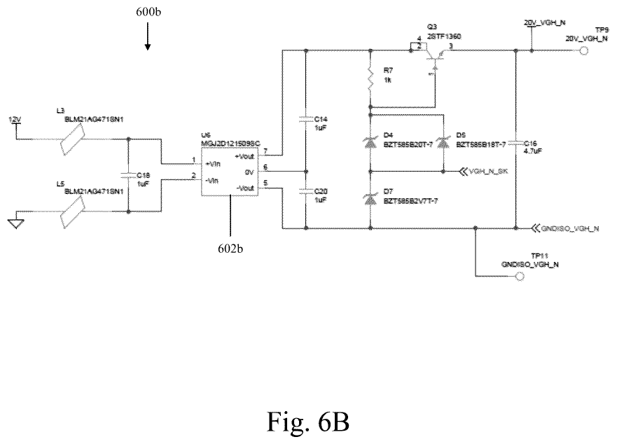

FIG. 8 is an overcurrent regulator 146a that can be implemented within the one or more regulators 146 depicted in FIG. 1D. The overcurrent regulator 146a can output one or more signals OVER_CURRENT indicative of a current value that exceeds a predetermined threshold. This signal OVER_CURRENT can be provided to controller 148.

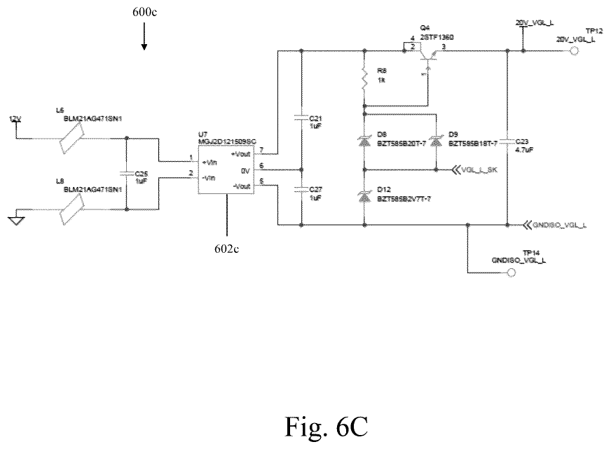

FIG. 9 is an overvoltage regulator 146b that can be implemented within the one or more regulators 146 depicted in FIG. 1D. The overvoltage regulator 146b can output one or more signals OVER_VOLTAGE indicative of a voltage value that exceeds a predetermined threshold. This signal OVER_VOLTAGE can be provided to controller 148.

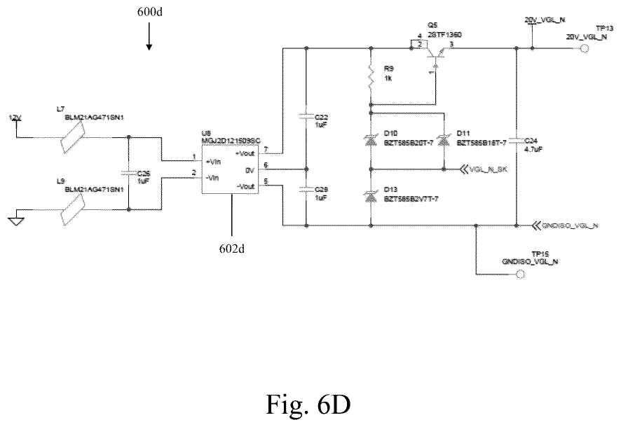

FIG. 10 is an AC regulator 146c that can be implemented within the one or more regulators 146 depicted in FIG. 1D. The AC regulator 146c can output one or more signals AC_GOOD indicative of an improper AC signal. This signal AC_GOOD can be provided to controller 148.

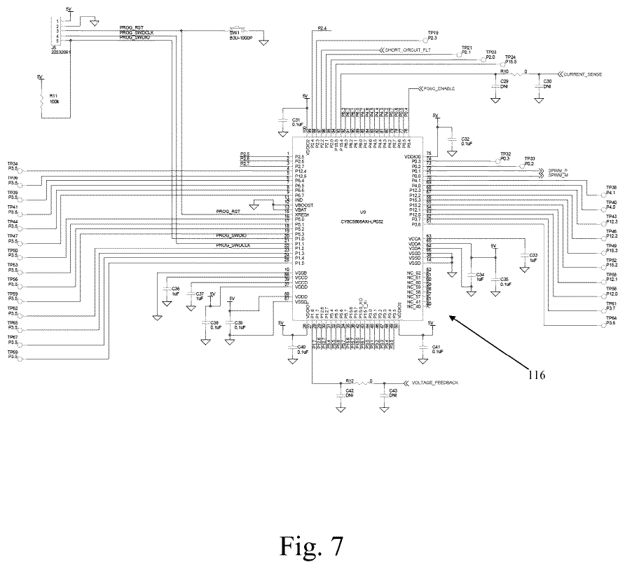

FIG. 11 is an undervoltage regulator 146d that can be implemented within the one or more regulators 146 depicted in FIG. 1D. The undervoltage regulator 146d can output one or more signals UNDER_VOLTAGE indicative of a voltage value that does not meet a predetermined threshold. This signal UNDER_VOLTAGE can be provided to controller 148.

The sensors depicted in FIGS. 8-11 can connect to the controller 116, for example at any of pins 1, 2, and/or 3.

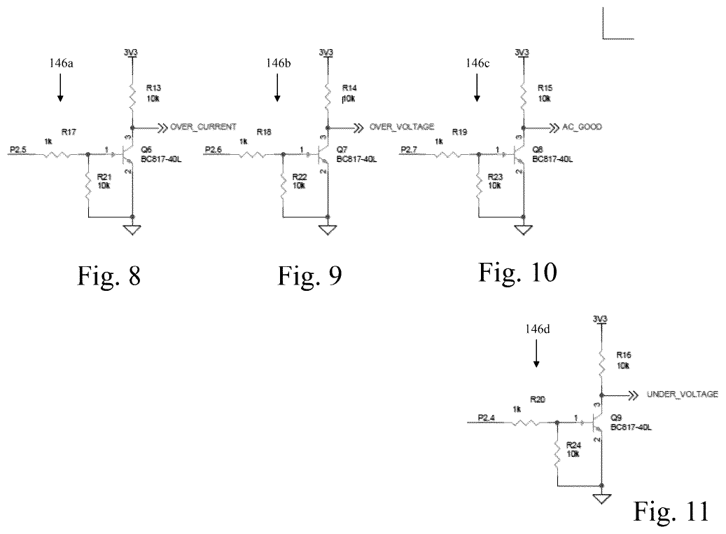

FIG. 12 shows a controller 148 electrically connected with a power switch 1205 and a bus switch 1210.

The controller 148 can be any type of controller having a 32-bit processor, read only memory, random access memory, and any other components typically found in a general-purpose computer. In one example, the controller 148 is an ESP32 manufactured by Espressif. The controller 148 can include one or more wireless communication protocols, such as WiFi pursuant to 802.11b/g/n or Bluetooth capability.

The controller 148 can receive one or more signals from the regulators 146. For example, the microcontroller 148 can be electrically connected to regulators 146a-d and receive signals OVER_VOLTAGE, UNDER_VOLTAGE, OVER_CURRENT, SHORT_CIRCUIT (also referred to as SHORT_CIRCUIT_FLT), and/or AC_GOOD indicative of overcurrent, overvoltage, AC signal, and undervoltage. The controller 148 can output the PSoC_ENABLE signal from port 1013 in order to activate and/or deactivate the AC output power from controller 116.

The power relay switch 1205 can be electrically connected to the controller 148 and can output one or more relay signals RELAY_1, RELAY_2, RELAY_3, RELAY_4, RELAY_5, RELAY_6. The relay drive signals (e.g., RELAY_1 through RELAY_6) can originate from controller 148 and the power relay switch 1205 can provide a current boost to drive the relays (e.g., 2110a, b, c, d, and/or 2210a, b, c, d) directly.

From pin 1013, the controller 148 can output a PSOC_ENABLE signal that can be transmitted to controller 116.

The bus switch 1210 can be electrically connected to controller 148, a temperature sensor 1215, humidity sensor 1220, and to one or more LED boards 1225.

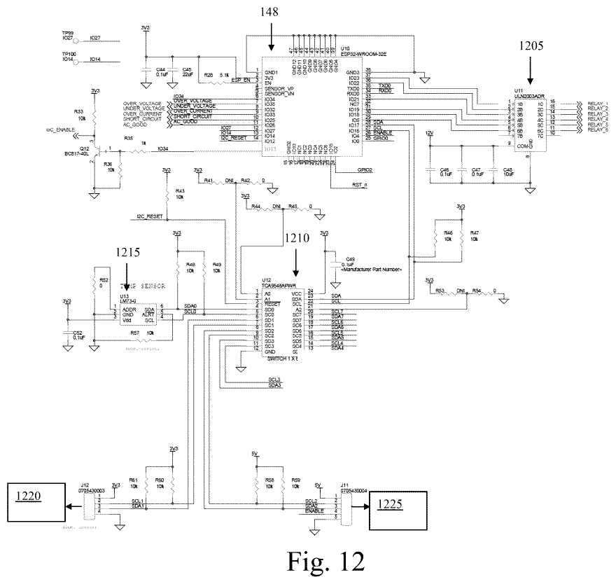

FIG. 13 is a port 1300 corresponding to the controller 148. In this regard, the microcontroller may connect to one or more external devices by a wired connection.

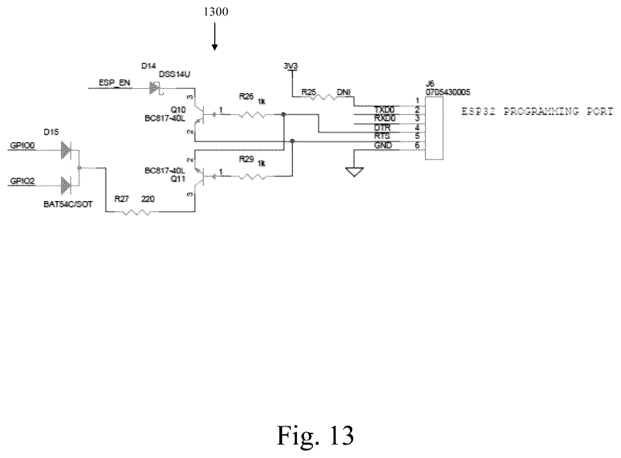

FIG. 14 is an analog to digital converter (ADC) 150 configured to convert one or more analog signals to one or more digital signals. The ADC 150 can receive one or more analog signals indicative of current from the one or more outlets. For example, the ADC 150 can receive I_SENSE_OUT_1, I_SENSE_OUT_2, I_SENSE_OUT_3, and/or I_SENSE_OUT_4. The ADC 150 can output one or more digital signals indicative of current and can transmit the signals to bus switch 1210.

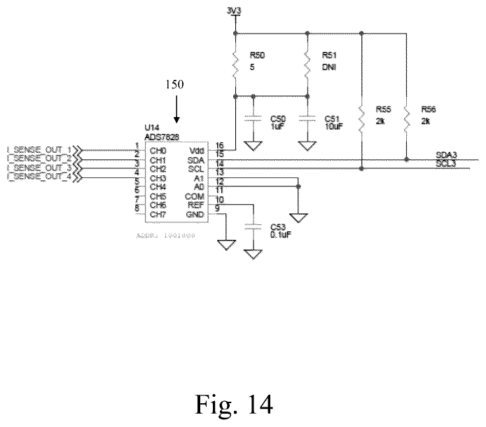

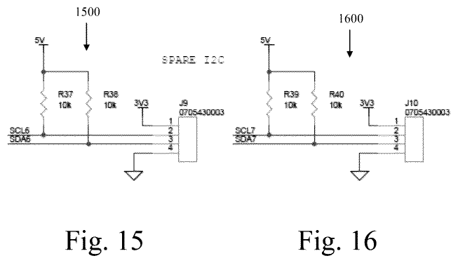

FIGS. 15-16 are additional 12C interfaces 1500 and 1600 configured to electrically connect to bus switch 1210.

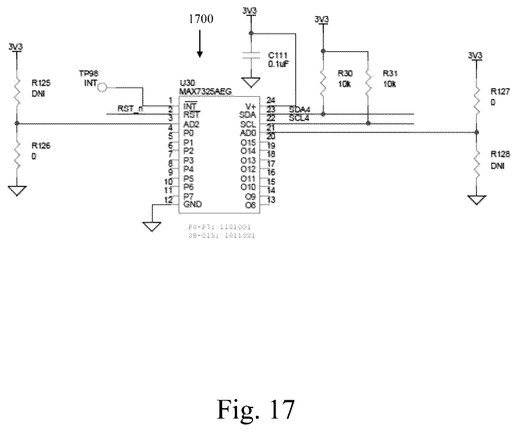

FIG. 17 is a port expander 1700 electrically connectible to the bus switch 1210.

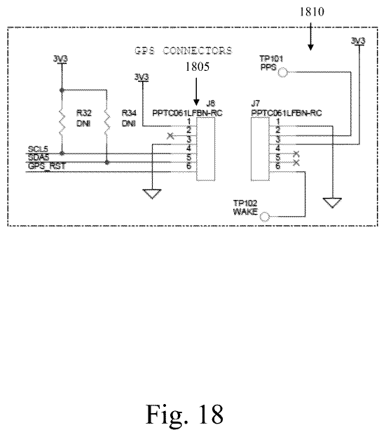

FIG. 18 are GPS connection interfaces 1805, 1810 configured to electrically connect to bus switch 1210.

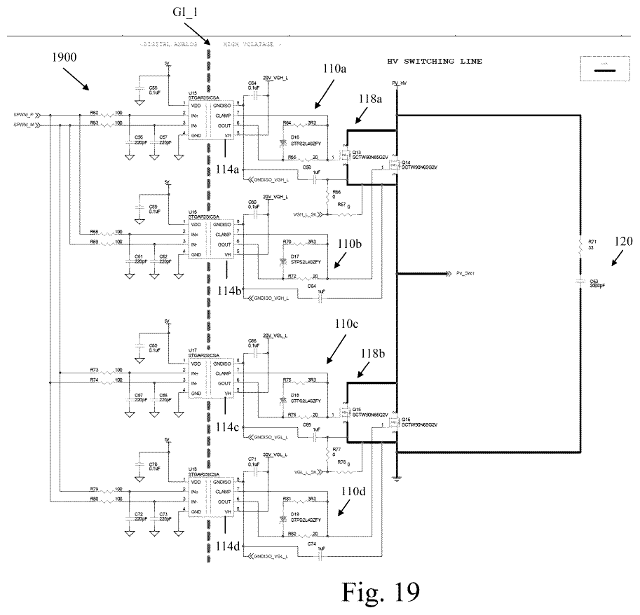

FIG. 19 shows a high voltage switching assembly 1900 for a generating a filtered first AC signal PV_SW1. The AC signal PV_SW1 can be a line signal for providing alternating current voltage (VAC) to the one or more outlets.

With reference to FIG. 1D, the high voltage switching assembly 1900 can include one or more single gate drivers 114, a half H-bridge assembly 110, overcurrent protection 118, and a filter 120.

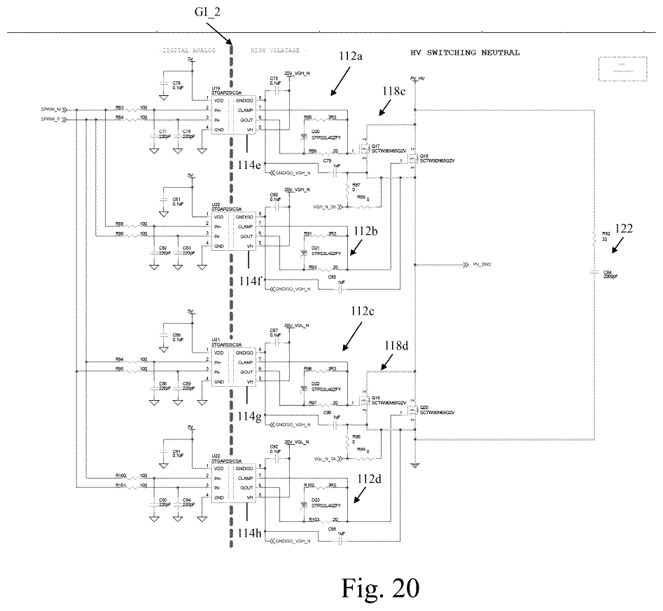

FIG. 20 shows a high voltage switching assembly 2000 for a generating a filtered second AC signal PV_SW2. The AC signal PV_SW2 can be a neutral signal for providing alternating current voltage (VAC) to the one or more outlets. With reference to FIG. 1D, the high voltage switching assembly 2000 can include one or more single gate drivers 114, a half H-bridge assembly 112, overcurrent protection 118, and a filter 122.

The switching assembly 1900 can include one or more single gate drivers 114a-d. Each of the single gate drivers 114a-d may receive the pulse modulated signals SPWM_P and/or SPWM_M from controller 116 and may be respectively powered at pin GNDISO. As shown, single gate drivers 114a-b can be powered at the GNDISO pins by the GNDISO_VGH_L signal received from voltage supply 600a. Single gate drivers 114c-d can be powered at the GNDISO pins by the GNDISO_VGL_L signal received from voltage supply 600c. The VGH_L_SK signal is a MOSFET source pin ground reference to tie the single gate drivers 114a-b to the MOSFET through its 20V power supply ground and the VGL_L_SK signal is a MOSFET source pin ground reference to tie the single gate drivers 114a-b to the MOSFET through its 20V power supply ground. Advantageously, the single gate drivers 114a-d include clamping protection and dead time reduction features.

Further advantageously, each of the single gate drivers 114a-d provide galvanic isolation, generally indicated by line GI_1. Galvanic isolation between the digital/analog components of the system 100 and the high voltage components of the system 100 advantageously allows for a reduction of noise and allow for voltage isolation, thereby providing for increased MOSFET stability for the system.

Each of the single gate drivers 114a-d can output a signal at the GOUT pin to half H-bridge circuits 110a-d, with half-H bridge circuits 110a-b being electrically connected to an overcurrent protection circuit 118a and half-H bridge circuits 110c-d being electrically connected to an overcurrent protection circuit 118b. The half-H bridge circuits 110a-d can be electrically connected to a low pass filter 120 and can output a high voltage AC signal PV_SW1.

The switching assembly 2000 can include one or more single gate drivers 114e-h. Each of the single gate drivers 114e-h may receive the pulse modulated signals SPWM_P and/or SPWM_M from controller 116 and may be respectively powered at pin GNDISO. As shown, single gate drivers 114e-f can be powered at the GNDISO pins by the GNDISO_VGH_N signal received from voltage supply 600b. Single gate drivers 114g-h can be powered at the GNDISO pins by the GNDISO_VGL_N signal received from voltage supply 600d. The VGH_N_SK signal is a MOSFET source pin ground reference to tie the single gate drivers 114e-f to the MOSFET through its 20V power supply ground and the VGL_N_SK signal is a MOSFET source pin ground reference to tie the single gate drivers 114e-f to the MOSFET through its 20V power supply ground. Advantageously, the single gate drivers 114a-d include clamping protection and dead time reduction features.

Further advantageously, each of the single gate drivers 114e-h provide galvanic isolation, generally indicated by line GI_2.

Each of the single gate drivers 114e-h can output a signal at the GOUT pin to half H-bridge circuits 112a-d, with half-H bridge circuits 112a-b being electrically connected to an overcurrent protection circuit 118c and half-H bridge circuits 112c-d being electrically connected to an overcurrent protection circuit 118d. The half-H bridge circuits 112a-d can be electrically connected to a low pass filter 120 and can output a high voltage AC signal PV_SW2.

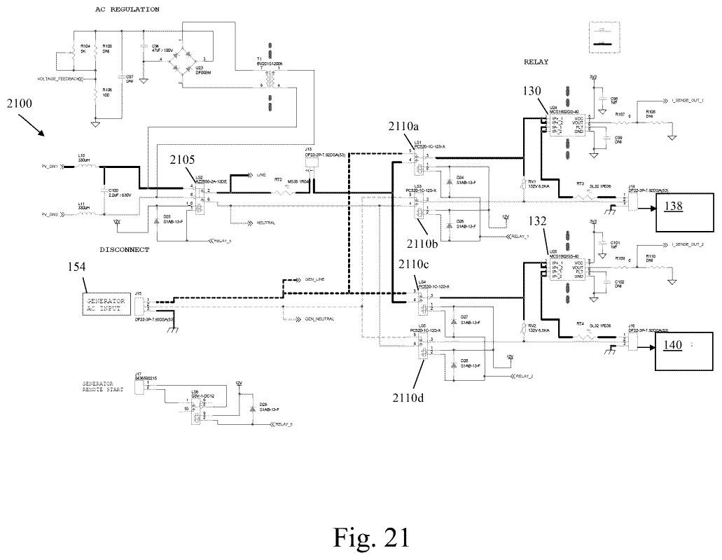

FIG. 21 shows an AC regulation assembly 2100 for the first and second outlets. With reference to FIG. 1D, the AC regulation assembly 2100 can include A C relay matrix 128 and/or sensors 130-132 and can provide an AC signal to one or more outlets 138-140.

As shown, the AC regulation assembly 2100 can include a first relay 2105 and a plurality of second relays 2110a-d. The first relay 2105 may be a 40-amp power relay and the plurality of second relays 2110a-d may be 1-amp relays. The AC regulation assembly 2100 can include sensors 130 and 132. The sensors 130 and 132 may be linear hall-effect current sensors configured to output a voltage proportional to a sensed current.

As also shown, the AC regulation assembly 2100 can receive the AC line and neutral signals (PV_SW1 and PV_SW2) from the filters 124 and/or 126. The PV_SW1 and PV_SW2 signals may be provided to controller 116 via VOLTAGE_FEEDBACK signal. In response to VOLTAGE_FEEDBACK signal, the controller 116 can modify the pulse width modulation frequency and duty cycle of outputs SPWM_M and/or SPWM_P. The first relay 2105 may receive A C line and neutral signals (PV_SW1 and PV_SW2) and RELAY_5 signal from power switch 1205 to generate LINE and NEUTRAL signals to be sent to outlets 138-144. The RELAY_5 signal may serve as a main power safety disconnect.

Advantageously, the LINE and NEUTRAL signals generated by inverter system 100 from renewable source 102 can be a usable 120 VAC pure sine wave power signal. The inverter system 100 can have a capability of providing up to and including 3,000 Watts of power to an external load. The inverter system 100 can convert the DC power from a renewable energy source to the 120 VAC pure sine wave power signal with superior efficiency.

For example, with an input power of 567.8 W from renewable energy source 102, the inverter system 100 can generate up to and including 564.126 W of 120 VAC pure sine wave power signal with an efficiency of approximately 99.35%. With an input power of 1062.5 W from renewable energy source 102, the inverter system 100 can generate up to and including 1045.952 W of 120 VAC pure sine wave power signal with an efficiency of approximately 98.44%. With an input power of 1417.8 W from renewable energy source 102, the inverter system 100 can generate up to and including 1407.6 W of 120 VAC pure sine wave power signal with an efficiency of approximately 99.28%. With an input power of 1932.9 W from renewable energy source 102, the inverter system 100 can generate up to and including 1873.676 W of 120 VAC pure sine wave power signal with an efficiency of approximately 96.94%. With an input power of 2788 W from renewable energy source 102, the inverter system 100 can generate up to and including 2687.688 W of 120V AC pure sine wave power signal with an efficiency of approximately 96.40%. With an input power of 3655 W from renewable energy source 102, the inverter system 100 can generate up to and including 3427.03 W of 120 VAC pure sine wave power signal with an efficiency of approximately 93.76%.

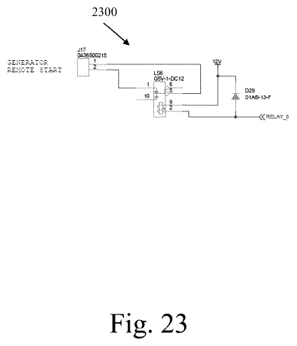

The inverter system 100 can electrically connect to (or can include) an external power source 154. The external power source 154 can be any type of power source capable of providing AC power. In one example, the external power source 154 can be a generator configured to provide an AC. In another example, the AC power source can be an electrical grid associated with a local city. The external power source 154 can generate GEN_LINE and GEN_NEUTRAL signals. FIG. 23 shows a remote start interface 2300 for generator. RELAY_6 may server as a generator remote start contact. Closing the relay can activate a remote start generator that is connected to the system.

Relay 2110a can receive the GEN_LINE signal and the LINE signal and relay 2110b can receive the GEN_NEUTRAL signal and the NEUTRAL signal. Based upon the RELAY_1 signal received from power switch 1205, the outlet 138 may be powered by LINE and NEUTRAL signals and thus be powered by the renewable energy source 102. Alternatively, the outlet 138 may be powered by GEN_LINE and GEN_NEUTRAL signals and thus be powered by the external power source 154.

The current sensor 130 can sense a current provided to a load that may be connected to outlet 138 and can output I_SENSE_OUT_1 to ADC 150, where it may be provided to controller 148.

Relay 2110c can receive the GEN_LINE signal and the LINE signal and relay 2110d can receive the GEN_NEUTRAL signal and the NEUTRAL signal. Based upon the RELAY_2 signal received from power switch 1205, the outlet 140 may be powered by LINE and NEUTRAL signals and thus be powered by the renewable energy source 102. Alternatively, the outlet 140 may be powered by GEN_LINE and GEN_NEUTRAL signals and thus be powered by the external power source 154.

The current sensor 132 can sense a current provided to a load that may be connected to outlet 140 and can output I_SENSE_OUT_2 to ADC 150, where it may be provided to controller 148.

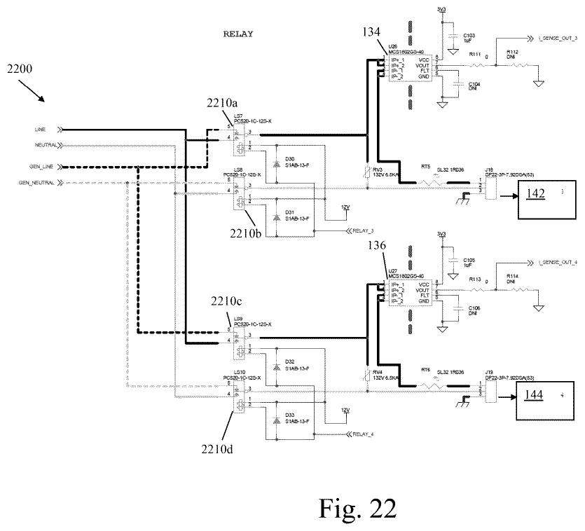

FIG. 22 shows an AC regulation assembly 2200 for the third and fourth outlets. With reference to FIG. 1D, the AC regulation assembly 2200 can include A C relay matrix 128 and/or sensors 134-136 and can provide an AC signal to one or more outlets 142-144.

As shown, the AC regulation assembly 2200 can include a plurality of relays 2210a-d. The relays 2210a-d may be 1-amp relays. The AC regulation assembly 2200 can include sensors 134 and 136. The sensors 134 and 136 may be linear hall-effect current sensors configured to output a voltage proportional to a sensed current.

Relay 2210a can receive the GEN_LINE signal and the LINE signal and relay 2110b can receive the GEN_NEUTRAL signal and the NEUTRAL signal. Based upon the RELAY_3 signal received from power switch 1205, the outlet 142 may be powered by LINE and NEUTRAL signals and thus be powered by the renewable energy source 102. Alternatively, the outlet 142 may be powered by GEN_LINE and GEN_NEUTRAL signals and thus be powered by the external power source 154.

The current sensor 134 can sense a current provided to a load that may be connected to outlet 142 and can output I_SENSE_OUT_3 to ADC 150, where it may be provided to controller 148.

Relay 2210c can receive the GEN_LINE signal and the LINE signal and relay 2110d can receive the GEN_NEUTRAL signal and the NEUTRAL signal. Based upon the RELAY 4 signal received from power switch 1205, the outlet 144 may be powered by LINE and NEUTRAL signals and thus be powered by the renewable energy source 102. Alternatively, the outlet 144 may be powered by GEN_LINE and GEN_NEUTRAL signals and thus be powered by the external power source 154.

The current sensor 136 can sense a current provided to a load that may be connected to outlet 144 and can output I_SENSE_OUT_4 to ADC 150, where it may be provided to controller 148.

### Forecaster Module

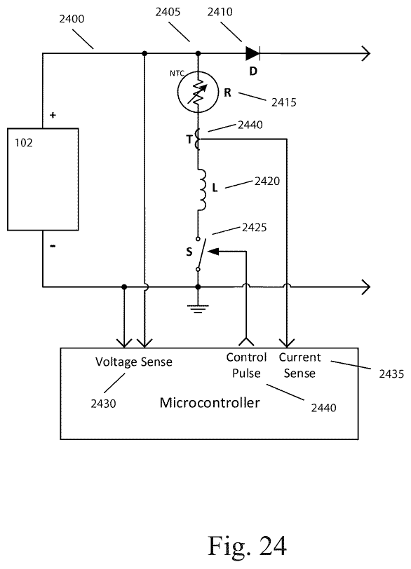

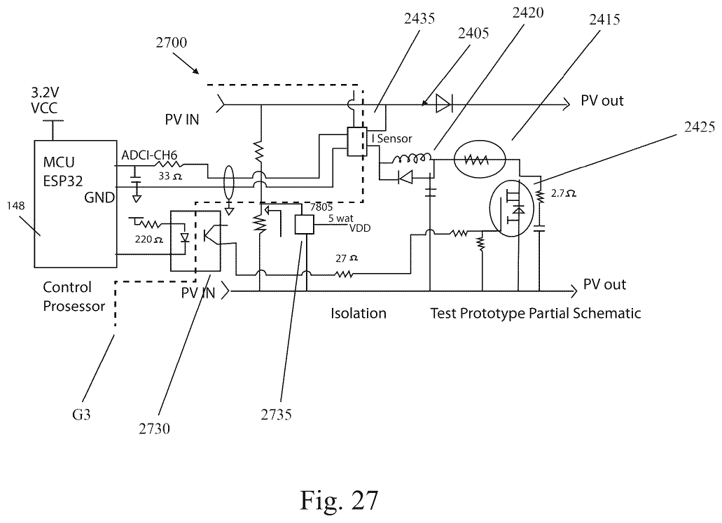

FIG. 24 is an electrical model of a forecaster module 2400 according to one or more aspects of the disclosure and FIG. 27 is a partial schematic of the shorting circuit 2405 electrically connected with the controller 148. The forecaster module can be incorporated into the inverter system 100 described above in order to measure and/or forecast an expected voltage that can be provided by renewable energy source 102.

In other examples, the forecaster module can be incorporated into a forecaster device (such as a handheld forecaster device having a processor, memory, etc.) that can be electrically connected and/or disconnected with the inverter system.

As shown, the forecaster module 2400 include a shorting circuit 2405 and can be electrically connected (directly or indirectly) to the renewable energy source 102 such that shorting circuit 2405 can act as a pseudo-load and draw a current from the renewable energy source 102.

The shorting circuit 2405 can include a diode 2410 (e.g., Schottky diode), an LR series circuit including a thermistor 2415 (e.g., used for surge protection with a value of 3 ohms) and inductor 2420 (dependent on the input voltage, can be greater than 1 milli-Henry), and a switch 2425. A voltage sensor 2430 can measure a voltage on a negative side of renewable energy source 102 and a current sensor 2435 (e.g., galvanically isolated current sense transformer) can measure a current between the thermistor 2415 and inductor 2420. As shown in FIG. 27, galvanic isolation can be provided along line G3 between the controller 148 and the shorting circuit 2405. As also shown, the shorting circuit 2405 can connect to the controller 148 via galvanically isolated gate pule driver 2730 (e.g., any of single gate drivers 114a-h) and a 5V gate pulse driver power supply 2735 referenced to the MOSFET source GND.

The switch 2425 can be controller by either or both of controller 116 and/or controller 148 such that either or both of controller 116 and/or controller 148 can open or close the switch 2425, for example by a control pulse 2440.

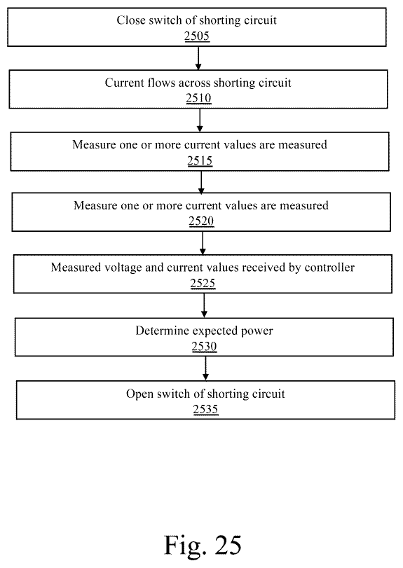

FIG. 25 is a method of forecasting, using the forecasting module 2400, according to one or more aspects of the disclosure. One or more program instructions stored at one or more memories (e.g., of forecaster module and/or controller 148) can be executed by one or more processors in order to perform the method steps described below. Advantageously, the method can be performed without an active load drawing power from the inverter system 100. In the example where the renewable energy source 102 is electrically connected to a load, the method of forecasting can be implemented without disrupting the power supply to the load.

At block 2505, the switch 2425, which is in a normally open state such that no current is drawn from renewable energy source 102, is closed. The switch 2425 can be closed based upon a control signal from either or both of controller 116 and/or controller 148.

At block 2510, current begins to flow across the shorting circuit 2405, and in particular, the LR series circuit including thermistor 2415 and inductor 2420.

At block 2515, one or more current values can be measured by current sensor 2435. In some examples, the current sensor can incorporate multisampling such that a plurality of measurements are taken, in connection with a capacitor, in order to generate more accurate current values.

At block 2520, one or more voltage values can be measured by voltage sensor 2430. Blocks 2515 and 2520 can be performed in any order or can be performed simultaneously.

At block 2525, the voltage and current values measured at blocks 2515 and 2520 are received by either or both of controller 116 and/or controller 148.

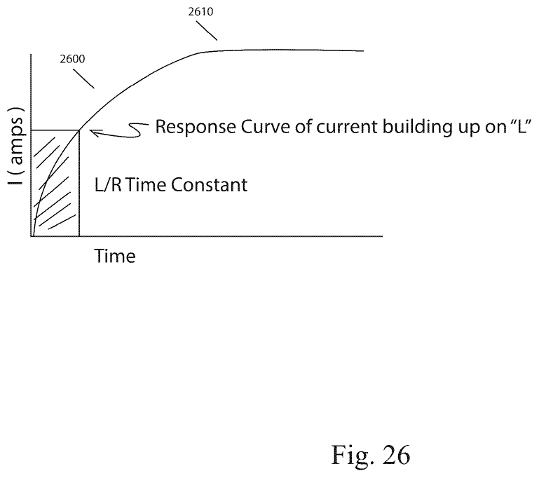

At block 2530, an expected power of the renewable energy source 102 is determined. The expected power can be determined by one or more factors, including one or more current values measured at block 2515, one or more voltage values measured at block 2520, prior voltage and/or current values from prior cycles. FIG. 26 is a graph of current (in amps) vs. time of a response curve 2600, showing current values as across the LR series circuit.

At t=0, the switch 2425 can be closed, thus allowing for current to flow across the LR series circuit. As time goes on, the current value increases until it reaches a maximum steady state current value 2610. The steady state current value 2610 is reached approximately at a shorting circuit time constant determined in part by the components of the shorting circuit. For example, the shorting circuit time constant can be the LR time constant, which is determined by the parameters of the thermistor and inductor of the LR series circuit. As the current is increasing, a plurality of current and or voltage values are measured.

Based upon the plurality of current and/or voltage values, a curve can be fit to the measured plurality of current and/or voltage values and a maximum steady state current can be estimated based upon the measured values. With the maximum steady state current, as well as one or more parameters of the renewable source 102 (such as Pmax, V@PMax, I@PMax, and/or short circuit current), a power output of the renewable source 102 can be calculated.

At block 2535, the switch 2425 can be opened based upon a control signal from either or both of controller 116 and/or controller 148. Once the switch 2425 is opened, current ceases to flow across the shorting circuit 2405. Where there is no load connected to the renewable source 102, current flowing from renewable source 102 ceases entirely. In this regard, the shorting circuit constitutes a pseudo-load, since power is drawn for a time less than the LR time constant and the current across the LR series circuit does not reach the maximum steady state current value.

Where there is a load connected to the renewable source 102, such as by one or more plugs of an inverter system that is electrically connected to the renewable source 102, the flow of current to the loads is uninterrupted or substantially uninterrupted based upon the short length of time between closing and opening of the switch, since the since power is drawn for a time less than the LR time constant and the current across the LR series circuit does not reach the maximum steady state current value.

The length of time between closing of the switch at block 2505 and opening the switch at block 2530 is variable. Referring back to FIG. 26, the switch 2425 can be closed before the current flowing across the LR series circuit reaches a maximum steady state value. In other words, the time between closing the switch 2425 and opening the switch 2425 in a single cycle can be less than the LR time constant associated with the LR series. In this regard, event duration is calculated by the L/R time constant for the circuit components L and R. The time constant represents the 63% position of the curve before reaching steady state. For example, if L/R=10 ms, then the pulse width duration is set to 10 ms. The pulse width cannot exceed the duration of L/R.

The switch 2425 can be opened at a predetermined time after the switch is opened, or may be opened at a variable time. In other examples, the switch may be opened based upon the measured current values. In this regard, where the current values exceed a predetermined threshold, or a parameter of a curve fit to the measured current values exceeds a threshold, the switch 2425 can be opened. A time period between opening the switch and a subsequent cycle is highly variable.

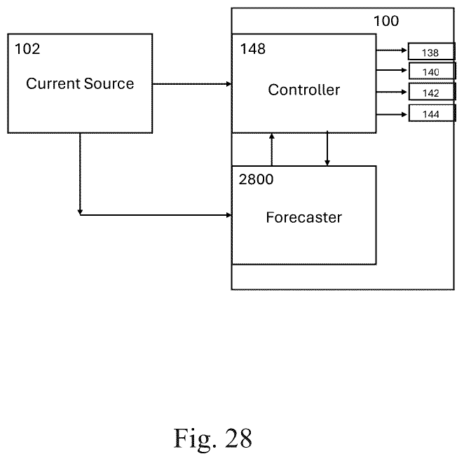

FIG. 28 is a block diagram of an inverter system 100 incorporating an exemplary forecaster module 2800 operatively connected to a current source 102 according to one or more aspects of the disclosure. The forecaster module 2800 can advantageously obtain accurate short circuit current (ISC) data without shutting down the inverter system 100 or power production from the current source 102 (e.g., one or more PV panels). This is achieved by rapidly (e.g., 650 microseconds or less) driving the current source 102 (e.g., one or more PV panels) into a controlled short circuit state and back again, minimizing stress on power components (e.g., components of the inverter system 100 or the loads drawing power from inverter system 100) and avoiding disruption of power to one or more loads drawing power from the inverter system 100.

As shown in FIG. 28, the forecaster module 2800 may be incorporated into the inverter system 100 by being operatively connected to a controller 148 and optionally being disposed within housing 102a. The forecaster 2800 can determine an available power of the current source 102 (e.g., one or more PV panel(s)), based at least in part by a measured short circuit current (ISC), and controller 148 can control the power provided to one or more loads connected to outlets 138-144, for example by the load shedding/switching techniques described below.

In other examples, the forecaster module 2800 can be incorporated into a forecaster device (such as a handheld forecaster device having a processor, memory, etc.) that can be electrically connected and/or disconnected with the inverter system 100.

As shown, the forecaster 2800 can be operatively connected to the current source 102 (e.g., one or more PV panels) such that current can briefly pass from current source 102 through forecaster 2800 and a short circuit current (ISC) can be determined. During operation of the short circuit current (ISC) determination, a local capacitor and/or battery may be used to power one or more circuits. For example, a 3300 microfarad capacitor in inverter system 100 can allow for power to be drawn from the inverter system 100 by the loads connected to outlets 138-144. Once the short circuit current (ISC) is determined, current flow can resume to the remaining components of inverter system 100 without interrupting power to the outlets 138-144 and loads connected to the outlets 138-144.

The inverter system 100 can also be operatively connected to the current source 102 (e.g., one or more PV panels) such that the controller 148 can measure a voltage across the terminals of the current source 102. For example, the controller 148 can measure a Volts Direct Current (VDC) when the inverter system 100, including controller 148, is operatively connected to one or more loads (e.g., via outlets 138-144). The VDC can be measured continuously during operation of inverter system 100. The controller 148 can also measure a Open-Circuit Voltage (VOC) when the current source 102 has no load connected. The VOC can be measured periodically throughout operation of the inverter system 100, for example at constant or variable intervals during operation during daylight hours. Further, the controller 148 can store the open-circuit voltage (VOC) of current source 102. In one example, the VOC is a known parameter of the current source 102. In another example, the controller 148 can determine an open-circuit voltage (VOC), or the maximum voltage of the current source 102, by taking voltage measurements of current source 102 without any load attached (e.g., VOC) and identifying a maximum value of the measurements. Optionally, an isolation amplifier and/or operational amplifier can be disposed between the current source 102 and controller 148 so that a voltage sensor onboard the controller 148 can measure voltage of the current source 102.

The controller 148 can initiate a short circuit current (ISC) determination by issuing at least one trigger signal from the controller 148 to the forecaster 2800. Upon receiving the trigger signal, the forecaster 2800 can determine a short circuit current (ISC) and transmit the determined short circuit current (ISC) to controller 148. The controller 148, based upon the VOC of current source 102, short circuit current (ISC) from current source 102, and a fill factor (e.g., 1.25), can determine an available power from the current source 102. The available power can be used by controller 148 to control power provided to outlets 138-144 and the one or more loads connected to the outlets 138-144, for example by the load shedding/switching techniques described below.

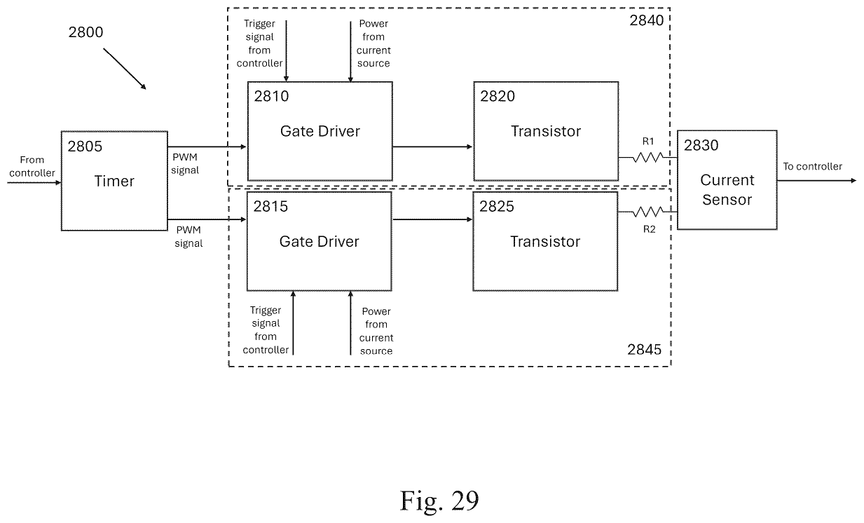

FIG. 29 is a schematic diagram of a forecaster 2800 according to one or more aspects of the disclosure.

The forecaster 2800 can include a timer 2805 (e.g., 555 delay timer), such as a 555 timing circuit by Texas Instruments. The timer 2805 is configured to introduce a delay in the activation of first and second gate drivers 2810-2815 at system startup. This brief delay ensures that the first and second gate drivers 2810-2815 do not receive an inadvertent signal during initial power on of controller 148, where the general purpose input/output pins (GPIO pins) may be in an indeterminate state. By preventing premature activation of first and second gate drivers 2810-2815, the timer 2805 can prevent the system from unintentional turn-on of the transistors 2820-2825 (described below), which could otherwise result in an unsafe clamping condition or system fault.

The forecaster 2800 can include a first gate driver 2810 and a second gate driver 2815 each operatively connected to the timer 2805 such that the timer 2805 can introduce the delay in activation (as described above). The first and second gate drivers 2810, 2815 can be any type of high-performance gate driver suitable for switching high voltages or currents, such as single channel isolated gate driver ICs offered by Infineon Technologies. The first and second gate drivers 2810, 2815 can be configured for approximately 6 A output and can include integrated Miller clamps to prevent false turn-on due to gate-drain capacitance effects, enabling safe and efficient operation of the short circuit current (ISC) determination.

The first gate driver 2810 can be operatively connected to controller 148 so that first gate driver can receive a trigger signal from controller 148. The first gate driver 2810 can be operatively connected to current source 102 so that current can flow from the current source 102, through first gate driver 2810, and to transistor 2820. The trigger signal received from controller 148 can be to switch the first gate driver 2810 ON, allowing current to pass through the first short circuit path 2840, e.g., from current source 102 to gate driver 2810 to transistor 2820 to first resistor R1 (also referred to as “current limiting resistor”) and to current sensor 2830. The trigger signal received from controller 148 can be to switch the first gate driver 2810 OFF such that the current source 102 can deliver power to the remaining components of inverter system 100. The resistor R1 can have a constant resistance value and in one example can be 10 ohms or less. In one example, the resistance can be 2.7 ohms.

The second gate driver 2815 can be operatively connected to controller 148 so that second gate driver 2815 can receive a trigger signal from controller 148. The second gate driver 2815 can be operatively connected to current source 102 so that current can flow from the current source 102, through second gate driver 2815, and to transistor 2825. The trigger signal received from controller 148 can be to switch the second gate driver 2815 ON, allowing current to pass through the second short circuit path 2845, e.g., from current source 102 to gate driver 2815 to transistor 2825 to second resistor R2 (also referred to as “near-zero resistor”) and to current sensor 2830. The trigger signal received from controller 148 can be to switch the first gate driver 2815 OFF such that the current source 102 can deliver power to the remaining components of inverter system 100. The resistor R2 can have a constant resistance value and can be less than the constant resistance value of resistor R1. In one example, the resistance of R2 can be near zero, e.g., less than 1 ohm. As shown, the first and second short circuit paths 2840, 2845 are arranged in parallel.

The second gate driver 2815 receive one or more pulse width modulated (PWM) signals from controller 148. The frequency of the PWM signal (e.g., the duty cycle) can be in the range of 10-30 kHz, and in some examples can be in the range of 16-20 kHz. In some examples, the PWM signal can be a constant frequency or can be variable, depending upon one or more current measurements previously taken by current sensor 2830. In this regard, the controller 148 can dynamically adjust the duty cycle of the pulse (e.g, shown at output 3115 below), allowing for quicker stabilization of measured current upon the ISC plateau.

The forecaster 2800 can include a first transistor 2820 operatively connected to first gate driver 2810 and a second transistor 2825 operatively connected to second gate driver 2815. In one example, the first and second transistors 2820 and 2825 are insulated gate bipolar transistors (IGBTs). In the example of IGBTs, suitable IGBTs can be selected based upon current rating, voltage rating, and/or RDS(ON) gate voltage of the IGBTs. Advantageously, an IGBT has a safe operating area (SOA) conductive to PV panels and can conduct high-speed switching in a high current environment. In other examples, the transistors 2820-2825 can be MOSFETs, GaN FETs, or any other transistor configured for switching in a high current or voltage environment.

The second transistor 2825 can utilize PWM signals orchestrated directly by the controller. These signals are currently configured at a frequency of approximately 20 kHz. With a duty cycle based on previously recorded current sensors 2830 measurements, the controller can dynamically adjust the duty cycle of the second-stage pulse 2825 embedded within the stage 1 pulse 2820, allowing for a quicker path to ISC plateau.

The current sensor 2830 can measure a current from either or both short circuit paths 2840 and/or 2845. Based upon the current values measured at current sensor 2830, a short circuit current (ISC) can be determined, and an available power can be determined based in part upon the short circuit current (ISC).

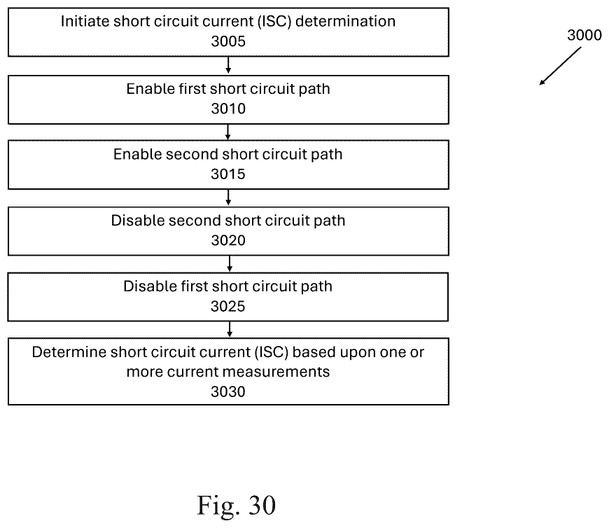

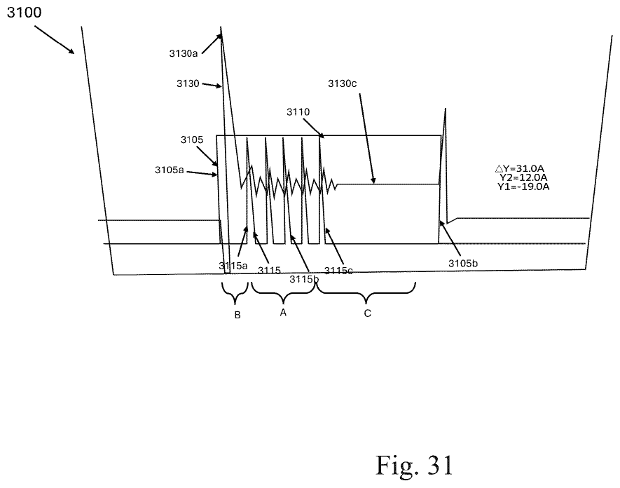

FIG. 30 is a flow chart depicting a method 3000 of determining a short circuit current (ISC) according to one or more aspects of the disclosure. FIG. 31 is an oscilloscope output of current vs. time showing the various stages of method 3000, including output 3110 of first gate driver 2810, the output 3115 of second gate driver 2815, and measured current 3130 by current sensor 2830.

At block 3005, a short circuit current (ISC) determination can be initiated. The short circuit current (ISC) determination can be initiated by a trigger signal from controller 148. The ISC measurement can be initiated at a predetermined time interval or can be initiated at a variable time interval based upon one or more conditions. In one example, the condition to initiate a trigger signal can be based upon a previously determined available power (e.g., from a previous iteration of method 3000). For example, where the previously determined available power exceeds a predetermined threshold, such as 3500 W, the short circuit current (ISC) determinations can be initiated at a predetermined time interval. Where the previously predetermined available power is below the predetermined threshold, the frequency of short circuit current (ISC) determination can be based upon a difference between previously determined available power and an amount of available power not being used by one or more loads connected to the outlets. Stated another way, the less available power and unused, the more frequent the short circuit current (ISC) determination.

At block 3010, a first short circuit path (e.g., first short circuit path 2840) is enabled. In this regard, the gate driver 2810 receives the trigger signal from controller 148 and switches ON. Since the resistance value of resistor R1 (e.g., current limiting resistor) is relatively low (e.g., 10 ohms or less), current travels through the switched gate driver 2810, transistor 2820, resistor R1 and ultimately to current sensor 2830, where current measurements (e.g., samples) are taken continuously while the first short circuit path 2840 is enabled. The first short circuit path 2840 can be enabled for a constant. In one example, the first short circuit path 2840 can be enabled for approximately 1000 to 2000 microseconds, and in one example can be 1800 microseconds or less.

Turning to FIG. 31, the enablement of first short circuit path 2840 can be seen at rising edge 3105a in the output 3105 of gate driver 2810. Upon enabling the first short circuit path 2840, the current measured 3130 by current sensor 2830 shows an initial spike 3110a and subsequently begins to stabilize about the short circuit current (ISC) plateau 3130c. During the stabilization, the measured current 3130 may oscillate above or below the short circuit current (ISC) plateau 3130c.

At block 3015, a second short circuit path (e.g., second short circuit path 2845) is enabled. In this regard, the gate driver 2815 receives the trigger signal from controller 148 and switches ON. Since the resistance value of R2 (e.g., near-zero resistor) is near-zero and/or less than the resistance value of resistor R1, current travels through gate driver 2815, transistor 2825, resistor R2, and current sensor 2830.

Enablement of the second short circuit path 2845 can occur at some time period after enablement of first short circuit path 2840, for example by a time period B. In one example, the time period B representing the time between enablement of the second short circuit path 2845 after enablement of the first short circuit path 2840 at block 3010 can be approximately 50 microseconds. This period of time B can be constant or can be variable based at least in part upon the frequency of PWM signal from timer 2805. The second short circuit path 2845 can be enabled for a constant or variable time. In one example, the second short circuit path 2845 can be enabled for approximately 250 to 800 microseconds, and in one example 650 microseconds or less.

The enablement of second short circuit path 2845 can be seen in the first rising edge 3115a output 3115 of second gate driver 2815. The output 3115 of second gate driver 2815 can include a plurality

Since the second gate driver 2815 output is modulated based upon PWM signal from timer 2805, the waveform output 3115 of the gate driver 2815 output can be a rectangular (or approximately) waveform, resulting in a plurality of pulses 3115b at a constant or variable frequency. In some examples, where enablement of first short circuit path 2840 results in a current measurement demonstrating over 3500 W in available power.

During the period of time when both first and second short circuit paths 2840-45 are enabled (e.g., the overlap time A), the measured current 3130 can oscillates about the ISC plateau 3130c and begin to stabilize about ISC plateau 3130c. In the example of FIG. 31, the stabilization can begin just slightly before enabling the second short circuit path 2845 (e.g., during period B), although in other examples, the stabilization can begin after enabling the second short circuit path 2845 (e.g., during period A).

The frequency of the PWM output 3115 of gate driver 2815, as mentioned above, can be in the range of 10-30 kHz, and in one example can be 20 kHz. The duty cycle (e.g., percentage of time the PWM output 3115 is ON during a cycle) of modulated gate driver 2815 output can be variable based at least in part on a measured current 3130. For example, the higher the measured current 3130, the less percentage of the duty cycle can be used. For a measured current below 3.0 A, a 100% duty cycle can be used; between 3-5 A, an 80% duty cycle can be used, between 5-7 A, a 60% duty cycle can be used, between 7-10 A, a 50% duty cycle can be used, and between 10-15 A, a 40% duty cycle can be used.

At block 3020, the second short circuit path 2845 is disabled. In this regard, the gate driver 2815 receives a trigger signal from controller 148 and switches OFF, allowing current to travel from the current source 102 through the first short circuit path 2840 via current limiting resistor R1 during time period C. In one example, the time period C can be approximately 350 microseconds, resulting in a total time of short circuit current (ISC) determination being approximately 1050 microseconds.

Disabling of second short circuit path 2845 can be seen as falling edge 3115c of the final pulse 3115b. While the falling edge 3115c of the final pulse is transmitted from second gate driver 2815 while measured current 3130 is still oscillating about ISC plateau 3130c (e.g., before the ultimate stabilization of current about ISC plateau 3130c), in some examples the measured current 3130 may stabilize at the ISC plateau 3130c prior to disabling of the second short circuit path 2845 (e.g., during time period A).

After disabling of the second short circuit path 2845 (or some time before, as mentioned above), the measured current 3130 stabilizes about the short circuit current (ISC) plateau 3130c33. Advantageously, the measured current can stabilize quickly. The short circuit current (ISC) can be determined (e.g., by controller 148) based upon the measured current 3130. For example, the determined short circuit current (ISC) can be a single current measurement taken during the ISC plateau 3130c. In another example, the determined short circuit current (ISC) can be an average of a plurality of measurements taken by controller 148 during ISC plateau 3130c.

At block 3020, the first short circuit path 2840 is disabled, allowing current to pass back to the remaining components of inverter system 100, where it can be converted from AC to DC and used to power one or more loads via outlets 138-144. The disabling of first short circuit path 2840 can be seen as falling edge 3105b. The period of time that first short circuit path is enabled can be a constant or variable time. In one example, first short circuit path can be enabled for approximately 1800 microseconds.

With the determined short circuit current (ISC), an available power can be determined. In one example, the available power can be determined as P=ISC×VOC×fill factor, where P is available power, ISC is short circuit current, VOC is maximum voltage of current source 102, and fill factor is a constant. Based upon available power P, load shedding or switching can occur as described below.

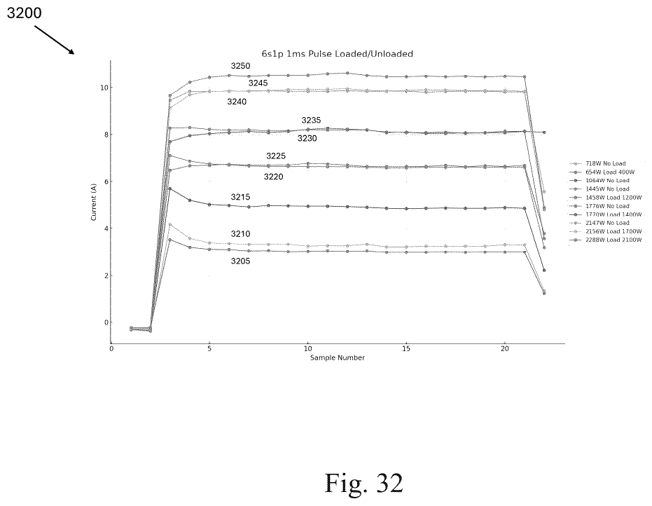

FIG. 32 is a graph 3200 showing current (A) vs. current measurement sample number showing stabilization of measured current about the ISC plateau of various powers and loads. As shown, output 3205 represents a power of 718 W and no load, output 3210 represents a power of 654 W and 400 W load, output 3215 represents a power of 1064 W and no load, output 3220 represents a power of 1445 W and no load, output 3225 represents a power of 1458 W and 1200 W load, output 3230 represents a power of 1776 W and no load, output 3235 represents a power of 1770 W and 1400 W load, output 3240 represents a power of 2147 W and no load, output 3245 represents a power of 2156 W and 1700 W load, and output 3250 represents a power of 2288 W and 2100 W load.

As shown, the measured current stabilizes to the ISC in fewer than five samples across a wide range of available power and loads, and in some examples fewer than four samples. The sample value can be approximately 1 microseconds.

In one example, a system can include a plurality of forecasters that measure a plurality of PV arrays separately, and the short circuit current (ISC) of each of the PV arrays can be provided to a supervisory control system.

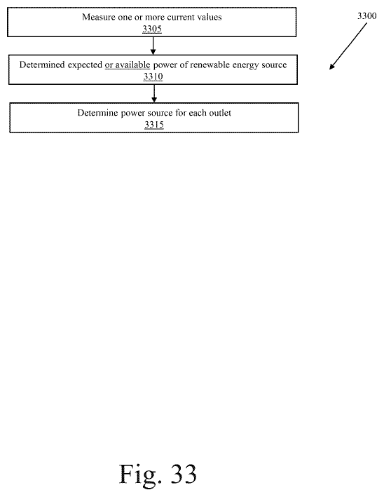

FIG. 33 is a method 3300 of determining a power source for one or more outlets according to one or more aspects of the disclosure. One or more program instructions stored at one or more memories (e.g., of forecaster module and/or controller 148) can be executed by one or more processors in order to perform the method steps described below.

At block 3305, one or more current values can be measured at each of the plurality of outlets. Referring to FIGS. 1D and 19-20, each of the current sensors 130-136 can measure a current value. This can be performed whether or not an external load is electrically connected to the respective outlets 138-144.

At block 3310, an expected or available power of the renewable energy source 102 can be determined. For example, the expected or available power (P=ISC×VOC×fill factor) can be determined using the forecasting methods (e.g., method 2500 or method 3000) described above.

At block 3315, a power source for each of the outlets is determined. In this regard, it is determined whether there is enough power to supply any or each of the outlets 138-144 based upon the expected or available power of the renewable energy source 102 and the measured current values at each outlet. Power may then be provided to the outlets 138-144 using relays 2110a-d and 2210a-d. In this regard, the relays default to providing power from the external energy source. When the relay is energized by the relay signals (e.g., RELAY_1 to 4) from controller 148 and power switch 1205, power from the renewable energy source 102 will pass through to outlets.

If the expected power exceeds a first threshold (e.g., enough power to power the load connected to first outlet 138), power can be provided to the first outlet 138 via renewable energy source 102 by way of inverter system 100. Where the expected power exceeds the first threshold but is less than a second threshold required to power a second outlet, the second, third, and fourth outlets can be powered the external energy source.

If the expected power exceeds a second threshold (e.g., enough power to power the load connected to first outlet 138 and the load connected to second outlet 140), power can be provided to the first outlet 138 and second outlet 140 via renewable energy source 102 by way of inverter system 100. Where the expected power is less than a third threshold required to power a third outlet, the third and fourth outlets can be powered the external energy source.

If the expected power exceeds a third threshold (e.g., enough power to power the load connected to first outlet 138 and the load connected to second outlet 140 and the load connected to third outlet 142), power can be provided to the first outlet 138, second outlet 140, and third outlet 142 via renewable energy source 102 by way of inverter system 100. Where the expected power is less than a fourth threshold required to power a fourth outlet, fourth outlet can be powered the external energy source.

If the expected power exceeds a fourth threshold (e.g., enough power to power the load connected to first outlet 138 and the load connected to second outlet 140 and the load connected to third outlet 142 and the load connected to fourth outlet 144), power can be provided to the first outlet 138, second outlet 140, third outlet 142, and fourth outlet 144 via renewable energy source 102 by way of inverter system 100.

In one example, each of the outlets 138-144 may be associated with a predetermined priority. For example, outlet 138 can have first priority, outlet 140 can have second priority, outlet 142 can have third priority, and outlet 144 can have fourth priority. Thus, where power is available from the renewable energy source via inverter system 100, power can be provided to the outlets 138-144 in order of priority (first, second, third, then fourth). Further, where available power from the renewable energy source via inverter system 100 reduces, power can be removed in order of priority (fourth, third, second, then first).

The blocks 3305 through 3315 can be performed at regular intervals or at variable intervals. Optionally, before providing power to an additional outlet from the inverter system, a predetermined amount of time may lapse. In this regard, the predetermined amount of time may be 20 seconds. Advantageously, this prevents a loop of instant switches between power sources in a manner that would disrupt power to the external load.

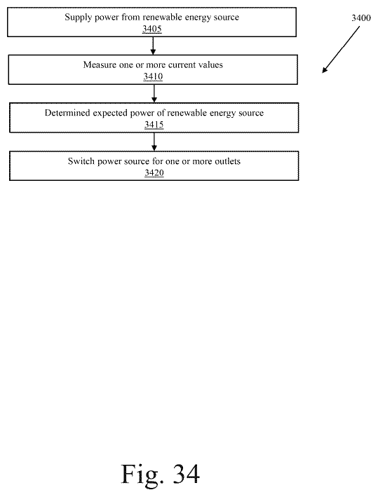

FIG. 34 is a method of load shedding according to one or more aspects of the disclosure. One or more program instructions stored at one or more memories (e.g., of forecaster module and/or controller 148) can be executed by one or more processors in order to perform the method steps described below.

At block 3405, power from a renewable energy source 102 can be supplied to at least some or all of the outlets.

At block 3410, one or more current values can be measured at each of the plurality of outlets. Referring to FIGS. 1D and 19-20, each of the current sensors 130-136 can measure a current value. This can be performed whether or not an external load is electrically connected to the respective outlets 138-144.

At block 3415, an expected or available power of the renewable energy source 102 can be determined. For example, the expected or available power (P=ISC×VOC×fill factor) can be determined using the forecasting methods (e.g., methods 2500 or 3000) described above.

At block 2920, power can be switched for one or more of the outlets. For example, the power supply can be switched from the renewable energy source via the inverter 100 or the external power source.

If the expected power exceeds a third threshold (e.g., enough power to power the load connected to first outlet 138 and the load connected to second outlet 140 and the load connected to third outlet 142) but does not meet a fourth threshold (e.g., enough power to power the load connected to first outlet 138 and the load connected to second outlet 140 and the load connected to third outlet 142 and the load connected to fourth outlet 144), power to the fourth outlet can be switched from inverter system 100 to external power source.

If the expected power exceeds a second threshold (e.g., enough power to power the load connected to first outlet 138 and the load connected to second outlet 140) but does not meet a third threshold, power to the third outlet (and optionally fourth outlet) can be switched from inverter system 100 to external power source.

If the expected power exceeds a first threshold (e.g., enough power to power the load connected to first outlet 138) but does not meet a second threshold, power to the second outlet (and optionally third and fourth outlets) can be switched from inverter system 100 to external power source.

If the expected power does not meet a first threshold, power to first outlet (and optionally third and fourth outlets) can be switched from inverter system 100 to external power source.

Advantageously, the loading switching and shedding methods can naturally stack loads to fit power availability without manual prioritization. Further, there is no requirement to net meter back excess power to the external energy source, where the external energy source is a town electrical grid.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. An inverter system, comprising:
a power inverter assembly configured to receive a DC voltage signal from a renewable energy source and convert the DC voltage signal to a first AC voltage signal;
a relay matrix configured to receive the first AC voltage signal from the power inverter assembly and a second AC voltage signal from an external power source in order to selectively power one or more outlets.

2. The inverter system of claim 1, wherein the power inverter assembly includes one or more single gate drivers configured to galvanically isolate digital and analog components from high voltage components.

3. The inverter system of claim 1, wherein the power inverter assembly includes a first controller comprising a sinusoidal pulse width modulator (SPWM).

4. The inverter system of claim 1, wherein the renewable energy source includes one or more photovoltaic panels.

5. The inverter system of claim 1, wherein the external power source is one of: a generator, or an electrical grid.

6. The inverter system of claim 1, further comprising:
a forecaster module configured to measure a current from the renewable energy source, the forecaster module including: a first short circuit path including a first transistor and a first resistor; and a second short circuit path including a second transistor and a second resistor.

7. The inverter system of claim 6, wherein the first transistor and the second transistor each comprise an insulated gate bipolar transistor (IGBT).

8. The inverter system of claim 7, wherein the first resistor has a greater resistance than the second resistor.

9. The inverter system of claim 1, further comprising:
one or more current sensors configured to measure a current draw at each of the one or more outlets.

10. A method of load switching and/or shedding, comprising:
measuring one or more current values associated with one or more outlets;
determining an available power from a renewable energy source; and
dynamically powering the one or more outlets from the renewable energy source or an external power supply.

11. The method of claim 10, wherein the one or more outlets comprises four duplex outlets, each of the duplex outlets having a predetermined priority.

12. The method of claim 10, wherein the determining the available power from the renewable energy source includes determining a short circuit current (ISC) of the renewable energy source.

13. A method of determining a short circuit current of a renewable energy source, comprising:
enabling a first short circuit path having a first transistor and a first resistor such that current is drawn from a renewable energy source;
enabling a second short circuit path having a second transistor and a second resistor such that current is drawn from the renewable energy source, the second resistor having a resistance that is less than a resistance of the first resistor;
disabling the second short circuit path;
measuring a current of the first short circuit path;
disabling the first short circuit path; and
determining a short circuit current of the renewable energy source based upon the measured current.

14. The method of claim 13, wherein the renewable energy source is operatively connected to an inverter system, and the first short circuit path is disabled before interrupting power to at least one load operatively connected to the inverter system.

15. The method of claim 13, wherein the measured current stabilizes at a short circuit current (ISC) plateau.

16. The method of claim 13, wherein the first short circuit path includes a first gate driver and the second short circuit path includes a second gate driver.

17. The method of claim 16, wherein an output of the second gate driver when the second short circuit path is enabled comprises a pulse width modulated (PWM) signal.

18. The method of claim 17, wherein the pulse width modulated (PWM) signal has a variable frequency based in part on a current measured after the first short circuit path is enabled.

19. The method of claim 13, wherein the second short circuit path is enabled for a duration of approximately 650 microseconds.

20. The method of claim 13, further comprising:
determining an available power based in part upon the determined short circuit current (ISC).
